(19) United States
(12) Patent Application Publication
(10) Pub. No.: US 2012/0177858 A1
(43) Pub. Date: Jul. 12, 2012

(54) POLYAMIDE COMPOSITIONS FOR FLOW MOLDING

(75) Inventor: Georgios Topoulos, Meyrin (CH)

(73) Assignee: E.I. DU PONT DE NEMOURS AND COMPANY, Wilmington, DE (US)

(21) Appl. No.: 13/346,024

(22) Filed: Jan. 9, 2012

Related U.S. Application Data
(60) Provisional application No. 61/431,156, filed on Jan. 10, 2011.

(51) Int. Cl. B32B 1/08; C08K 5/053

(52) U.S. Cl. 428/36.9; 524/387

(57) ABSTRACT

The present invention relates to polyamide compositions having improved crystallization rates for blow molding articles having complex shapes. The use of tripentaerythritol in polyamide compositions slows down the crystallization rate of the polyamide compositions so that they can be used to blow mold large parts having an excellent surface appearance. Due to the longer crystallization times, these polyamide compositions can be used to blow mold very large and intricate parts.

### CROSS REFERENCE TO RELATED APPLICATIONS

This application claims the benefit of priority to U.S. Provisional Application No. 61/431,156, filed Jan. 10, 2011.

### FIELD OF THE INVENTION

The present invention relates to polyamide compositions having improved crystallization rates for blow molding articles having complex shapes. More particularly the present invention relates to polyamide compositions incorporating specific concentrations of tripentaerythritol to achieve a slower rate of crystallization, which are especially useful when blow molding large parts which take a longer cycle time to mold than smaller parts. The invention also relates to blow molded articles prepared from these polyamide compositions.

### BACKGROUND OF THE INVENTION

The use of blow molding processes to manufacture end use articles is widely known. Blow molding can be used to produce a wide variety of articles, including bottles and automobile parts such as automotive parts for under the hood applications.

It is important in a blow molding process that the crystallization rate of the polymer used not be too fast or too slow. If the crystallization rate is too fast, the polymer could become brittle and rupture during blowing or surface defects could develop in the blow molded article. Unduly rapid crystallization is especially troublesome for relatively large blow molded articles where it takes more time to form the larger part. When crystallization is too slow, the period required to mold each article is lengthened, making the process uneconomical.

Polyamide resins have excellent toughness, strength, and chemical resistance, which make them useful as engineering resins for a wide variety of blow molded articles.

Nylon 6 and nylon 6,6 are two examples of polyamide resins commonly used for producing blow molded articles. For example, blow moldable thermoplastic polyamide resins are disclosed in U.S. Pat. No. 5,408,000. Several methods have been employed to slow the crystallization rate of these polymers for use in blow molding processes.

U.S. Pat. No. 6,756,444 teaches a blend of different polyamides to slow the crystallization rate of the polyamide composition, The composition comprises an amorphous, semiaromatic polyamide homopolymer, copolymer or mixture thereof and a semicrystalline, aliphatic polyamide homopolymer, copolymer or mixture thereof wherein in the weight ratio ranges from about 99:1 to about 30:70.

U.S. Pat. No. 5,846,478 teaches a polyamide blow molded product obtained from a three-component polyamide blend comprising polyamide 6T, polyamide 6I and polyamide 6,6. The blend is claimed to have a slow crystallization rate.

U.S. 20080070023 teaches the use of polyamide blend compositions to modify the crystallization rate of the polyamide.

U.S. 2010/0029819 A1 discloses a molded or extruded thermoplastic article having high heat stability including a thermoplastic resin, one or more polyhydric alcohols including tripentaerythritol, one or more reinforcing agents, and optionally, a polymeric toughener.

However, there is still a need to improve the crystallization rate of polyamide compositions for blow molding applications involving large parts.

### SUMMARY OF THE INVENTION

There is disclosed and claimed herein a thermoplastic composition comprising
(a) 27 to 91 weight percent of an aliphatic polyamide;
(b) 7 to 30 weight percent polymeric viscosity modifier comprising a reactive functional group, a metal salt of a carboxylic acid, or a combination of them;
(c) 1 to 40 weight percent of one or more reinforcing agents; and
(d) 1.0 to 3 weight percent of tripentaerythritol;

wherein said thermoplastic composition has an Ra value of less than or equal to 5.0 microns when blow molded using a Fisher Muller blow molding test; and wherein all weight percentages are based on the total weight of the thermoplastic composition.

Further disclosed are articles prepared from the thermoplastic composition.

### DETAILED DESCRIPTION OF THE INVENTION

Polyamide compositions comprising specific concentrations of tripentaerythritol have a slower rate of crystallization, as determined by DSC, compared to polyamide compositions that do not contain tripentaerythritol. Preferably compositions having TPE present have a peak of the crystallization endotherm of at least 2° C. lower than that of compositions having no TPE present. More preferably the compositions having TPE present have a peak of the crystallization endotherm of at least 2.5° C., or 3.0° C., lower than that of compositions having no TPE present. These polyamide compositions provide excellent blow molded articles where the article is of relatively large size. Slower crystallization rates of polyamide compositions are especially useful when blow molding large parts which take a longer cycle time to mold than smaller parts.

The polyamide composition comprises components: (a) a polyamide; (b) a viscosity modifier; (c) a reinforcing filler; and (d) a crystallization rate modifier.

### Definitions

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present).

As used herein, the term “reinforcing agent” means a material or materials added to the polyamide composition which serve to enhance the mechanical properties of the molded articles, including, but not limited to, stiffness and tensile strength.

As used herein, the term “polymeric viscosity modifier” means a polymeric material added to the polyamide composition which causes a modification or change in the viscosity of the polyamide composition when the polyamide composition is heated without significantly degrading physical properties of the polyamide composition such as impact resistance and tensile strength.

As used herein, the term “reactive functional group” means a functional group which reacts with the polyamide to form ionic or covalent bonds with a functional group of the polyamide.

As used herein, the term “aliphatic polyamide” means a polyamide prepared from at least one aliphatic diacid and at least one aliphatic diamine.

### Polyamide

The polyamide (a) of the invention is an aliphatic polyamide having both aliphatic diamine and aliphatic diacid repeat units. As used herein, “polyamide” means a condensation polymer in which 100 percent of the groups connecting repeat units are amide groups. Preferred polyamides include nylon 6,6; nylon 6; nylon 6,12; nylon 6,10; and nylon 10,10; and copolymers of nylon 6,6 and nylon 6 and blends thereof. The most preferred polyamide for use in this invention is polyamide 6,6. The numerical suffix of the polyamide specifies the numbers of carbons donated by the diamine and the diacid—the diamine first and the diacid second. Polyamide 6,6 is a polyamide prepared from hexamethylenediamine and hexane-1,6-dicarboxylic acid repeat units.

### Viscosity Modifier

The second component (b) of the invention is a viscosity modifier comprising a reactive functional group and/or a metal salt of a carboxylic acid. Viscosity modifiers can also function as tougheners. Examples of viscosity modifiers include ethylene based polymers such as ethylene alpha olefins grafted with carboxylic acid, unsaturated anhydrides, maleimide, or an epoxy compound and copolymers of ethylene copolymerized with acrylic acid, methacrylic acid, unsaturated anhydrides and mixtures thereof. Additional examples of viscosity modifiers include maleic anhydride grafted very low density polyethylene (VLDPE), maleic anhydride grafted ethylene propylene diene (EPDM) rubber, ionomers, styrenic thermoplastic elastomers grafted with maleic anhydride, or maleic anhydride modified styrene ethylene butyl styrene copolymers (SEBS) and mixtures thereof.

The very low density polyethylene (VLDPE) useful in the instant invention is essentially any such linear polyethylene generally known in the art having a density in the range of from about 0.89 to about 0.915. Such VLDPE is typically produced by copolymerization of predominantly ethylene and at least one C3 to C8 alpha-olefin comonomer. The maleic anhydride (MAN) grafted very low density polyethylene (MAN-g-VLDPE) is a VLDPE to which up to a few weight percent of maleic anhydride has been grafted. Typically from one to two percent maleic anhydride based on the weight of VLDPE is sufficient. The ethylene propylene elastomer (EPR) useful in the instant invention is essentially any such elastomer again as generally known in the art. Preferably the EPR will be an EPDM elastomeric terpolymer of ethylene, propylene and a third comonomer non-conjugated diene. Such elastomers are disclosed in U.S. Pat. Nos. 3,658,752; 3,758,643; and 4,078,020, incorporated herein by reference. The MAN grafted EPR and/or EPDM are also typically derived from a grafting reaction involving in which one to two percent maleic anhydride is grafted onto the polymer backbone. The actual grafting reaction for incorporating the maleic anhydride onto the polymer can be performed essentially by any of the methods generally known in the art. For purposes of the present invention, it is contemplated that other unsaturated dicarboxylic acid such as fumaric, itaconic and mesaconic acids having structures closely related to and potentially precursors to a similar anhydride after the grafting reaction should be considered equivalent to the MAN in the MAN grafted polymers.

A preferred polymeric viscosity modifier is a copolymer of ethylene, propylene and 1,4-hexadiene and, optionally, norbornadiene, said copolymer having grafted thereto an unsaturated monomer taken from the class consisting of fumaric acid, maleic acid, maleic anhydride, and the monoalkyl ester of said acids in which the alkyl group of the ester has 1 to 3 carbon atoms. For example, one such EPDM polymer is TRX 301 which is an EPDM grafted with maleic anhydride and available from the Dow Chemical Company (Midland, Mich., USA).

Another type of polymeric viscosity modifier containing a metal salt of a carboxylic acid is an ionomer that contains certain types of ionic groups. The term “ionomer” as used herein refers to a polymer with inorganic salt groups attached to the polymer chain (Encyclopedia of Polymer Science and Technology, 2nd ed., H. F. Mark and J. I. Kroschwitz eds., vol. 8, pp. 393-396). A preferred polymeric viscosity modifier of this type is an ionomer derived from alpha-olefin having the formula RCH═CH₂ wherein R is H or alkyl having from 1 to 8 carbon atoms and from 0.2 to 25 mole percent of units derived from an alpha, beta-ethylenically unsaturated mono- or dicarboxylic acid, at least 10% of the acid groups of said units being neutralized by metal ions having a valence of from 1 to 3, inclusive. Preferably, the ionomer will be a copolymer of ethylene and acrylic or methacrylic acid at least 10% neutralized by metal ions such as Li⁺, Zn⁺², Mg⁺², and/or Mn⁺². For example, one such polymer is DuPont™ Surlyn® resins available from E. I. du Pont de Nemours & Co., Inc., Wilmington, Del., USA.

Examples of epoxy based viscosity modifiers include epoxy resins prepared from epichlorohydrin and glycols. A preferred epoxy viscosity modifier is prepared from epichlorohydrin and propylene glycol and is available from The Dow Chemical Company as D.E.R. 732.

The amount of viscosity modifier (b) in the composition is from 7-30 weight percent, preferably 10-25 weight percent, or 12 to 25 weight percent, or 15 to 25 weight percent, based on the weight of the thermoplastic composition. These viscosity modifiers improve the flow properties of the resulting polyamide composition without significantly degrading physical properties such as impact resistance and tensile strength.

### Reinforcing Agent

The third component (c), a reinforcing agent of the blow molding composition of the invention, is preferably one or more of glass fibers, glass beads, glass flakes, carbon fibers or other fibers such as Kevlar® brand fiber or Kevlar® pulp, both available from E.I. DuPont de Nemours & Co, Inc., Wilmington, Del., mineral whiskers, wollastonite, kaolin or clay. More preferably, the reinforcing material is glass fibers having an average diameter of about 3 to 30 microns, preferably 5-20 microns, and more preferably 8-20 microns. Use of non round fiber cross section is also possible. The reinforcing material, in combination with the other components of the blow molding compositions of the invention, serve to enhance the mechanical properties of the molded articles, including higher stiffness, greater impact resistance, and higher tensile strength. The amount of reinforcing agent in the composition of the invention is from 1 to 40 weight percent, preferably from 10 to 40 weight percent based on the total weight of the composition. A preferred type of reinforcing agent is E-glass. E-glass is an alumino-borosilicate glass with less than 2 wt % alkali oxides, preferably less than 1 wt % alkali oxides. Chopped, sized glass fibers for the reinforcement of plastics are offered on the market by various manufacturers. Vetrotex 983 from Vetrotex, Chambéry, France; PPG 3660 and PPG 3786 from Pittsburgh Plate Glass, Pittsburgh, Pa., USA; and CS 7928 from Bayer, Leverkusen, Germany may be mentioned by way of example.

### Crystallization Rate Modifier

Tripentaerythritol (TPE) is the fourth component (d) and serves as the crystallization rate modifier for the polyamide compositions of this invention. TPE is a polyhydric alcohol. The amount of TPE in the polyamide composition of the invention is important to the surface quality of the blow molded part. The use of TPE in the polyamide compositions of from about 1 to about 3 percent, preferably from about 1 to 2.5 percent, and most preferably from about 1.5 to 2.5 weight percent provides large blow molded parts with excellent surface appearance. Dipentaerythritol (DPE) is also a polyhydric alcohol but it is not a crystallization rate modifier of the invention. The use of DPE as the crystallization rate modifier in the polyamide compositions of this invention results in blow molded parts which have surface defects such as holes in the blow molded part and fail the Fischer Muller blow molding test. DPE also results in a large blow molded part to have a rough surface.

### Additives

In practice, the viscosity modified polyamide compositions of the present invention will advantageously contain minor amounts, typically up to a few percent, of other additives such as pigments, coloring agents, carbon black, ultraviolet light (UV) stabilizers, antioxidants, processing aids, anti-slip agents, plasticizers, heat stabilizers, and the like. Various such additives and their respective use are well known in the art and commercially used in connection with polyamide blend compositions for blow molding. Typical preferred combinations are specifically illustrated in the examples.

Examples of heat stabilizers include phosphite and phosphonite stabilizers, hindered phenol stabilizers, hindered amine stabilizers and aromatic amine stabilizers. Such stabilizers function as process heat stabilizers and/or as product thermal stabilizers. Phosphites and phosphonites stabilizers include trivalent phosphorus compounds such as sodium hypophosphite (SHP); tris(2,4-di-tert- butylphenyl)phosphite; bis(2,4-dicumylphenyl))pentaerythritol diphosphite; dibenzo[d,f][1,3,2]dioxaphosphepin, ethanamine deriv.; tetrakis(2,4-di-tert-butylphenyl)[1,1-biphenyl]-4,4′-diylbisphosphonite; tris(2,4-ditert-butylphenyl)phosphite; and 2,2-methylene-bis(4,6-di-tert-butylphenyl)octylphosphite.

Hindered phenols stabilizers are aromatic products containing OH groups and are sterically hindered by bulky aliphatic side chains. Examples of hindered phenol stabilizers include pentaerythritol tetrakis(3-(3,5-di-tert-butyl-4 hydroxyphenyl)propionate); N-N′-hexane-1,6-diylbis(3-(3,5-di-tert-butyl-4-hydroxyphenylpropionamide)); and ethylenebis(oxyethylene)bis(3-(5-tert-butyl-4-hydroxy-m-tolyl)-propionate).

Hindered amine stabilizer are tetramethyl piperidine derivatives that are sterically hindered by bulky aliphatic side chains. Examples of hindered amine stabilizers include poly[[6-[(1,1,3,3-tetramethylbutylamino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); butanedioic acid, dimethylester polymer with 4-hydroxy-2,2,6,6-tetramethyl-1-piperidine ethanol; and bis (2,2,6,6,-tetramethyl-4-piperidyl) sebaceate.

Aromatic amine stabilizers are secondary aromatic amines. Examples of aromatic amine stabilizers include 4,4′ bis(alpha, alpha dimethylbenzyl) diphenylamine; and N,N′-diphenyl-1,4-phenylendiamine.

Another class of heat stabilizers include copper based heat stabilizers such as a copper iodide/potassium iodide mixture.

Carbon black can also be added to the compositions of the invention. Carbon black is typically added in a concentration of from 0.5 to 5 weight percent based on the total weight of the composition.

Another class of heat stabilizers which are not a class of heat stabilizers of this invention are ethylene unsaturated alcohol heat stabilizers. These heat stabilizers are produced from ethylene and unsaturated alcohol monomers. The addition of these ethylene unsaturated alcohol heat stabilizers to polyamide compositions of this invention result in blow molded parts that have inferior surfaces and do not pass the Fischer Muller blow molding test.

### Blow Molding Process

The blow molding process begins with producing a polymer melt in a horizontal extruder. In extrusion blow molding this high viscosity melt is extruded vertically through die tooling, forming a tube of molten resin called a “parison”. This parison tube is captured by a mold, pinching the top and bottom, inflated from its interior such that the parison expands to assume the shape of the surrounding mold cavity, and cooled while subjected to internal air pressure. The mold is then opened, yielding a rigid, hollow part.

Extrusion blow molding is done on equipment with a parison forming continuously or intermittently. The continuous blow molding method, generally limited to small and medium-sized parts, continuously forms a parison from one or more die heads, or alternates flow to multiple die heads. Molds can be fixed in position and dedicated to one die head or can shuttle on a swing arm or rotating wheel away from the head to complete the blowing and cooling steps.

Extrusion blow molding uses a pinch-off technique to close the mold for inflation. The mold closes, pinching the ends of the parison and forming a seal. The pinch-off size and location will vary with the part design and processing equipment used. The most common methods locate pinch-offs at either end of the parison or along the entire part perimeter,

The pinch-off can produce a weak area at the weld. As the mold closes, the resin composition has had some time to cool and undergo a variety of other changes after extrusion from the die head and does not weld as completely as fully molten resin. The amount of property loss varies with the resin composition, processing parameters, and mold design. Addition of TPE to the polyamide composition at specific concentrations slows down crystallization of the polyamide composition allowing for a longer cycle time and formation of large blow molded parts having an excellent surface appearance.

If crystallization proceeds too quickly, the part may not be capable of being properly blown or cannot be blown at all. In the first case, the part may show severe defects related to the premature crystallization, e.g. very bad surface with holes or non-uniform wall thickness. In the second case, the part cannot be formed at all because the polymer is crystallized before it could be ‘distributed’ or blown around the wall of the mould.

In a typical blow molding process, the polymer is injected into the vertical mold and the polymer must flow to the end of the mold furthest from the injection point (or gate) of the mold. If the polymer starts to crystallize before it can flow to the end of the mold furthest from the injection point, the part will have defects such as holes or a rough surface. These defects usually occur near the point in the mold furthest from the injection point.

### Method to Determine Rate of Crystallization

Rate of crystallization of polyamide compositions herein are determined by differential scanning calorimetry (DSC) in the first cooling cycle at a scan rate of 10 C/min from 290° C. to 40° C. The method comprises placing approximately 6 to 10 mg sample in a DSC aluminum pan; heating the sample to 40° C. for 1 minute hold period; heating from 40° C. to 290° C. at 10 C/min; holding at 290° C. for 1 minute period; cooling from 290° C. to 40° C. at 10 C/minute; and holding to 1.0 minute at 40° C. The temperature of the peak of the crystallization endotherm is a measure of the propensity for crystallization of the various compositions. The lower the peak temperature, the slower is the crystallization rate.

### Fischer Muller Blow Molding Test

The Fischer Muller blow molding test was performed on a Fisher Muller FMB-2/40 machine in standard suction mode. The mould used was an automotive air duct 120cm long, an external diameter of 50 mm, a thickness of 2.5 mm and having 6 bends with angles of 60 degrees, 85 degrees, 85 degrees, 65 degrees, 85 degrees, and 60 degrees starting from the injection point of the mold. The distance between each angle or bend is approximately 10 cm. The polymer melt temperature was set up to 290° C. and the mould temperature to 90° C. The expulsion time was set for 5 seconds. The expulsion time is the time between the moment the melt exits the accumulator head though the gate till the time air is blown to shape the part.

The blow molded part is then tested for surface roughness. Surface roughness is performed on the surface of the molded part that was in direct contact with the mold surface at a point near the bottom of the molded air duct. The bottom of the molded air duct is the part of the air duct furthest from the polymer injection point during formation of the part. A 6 mm length of the exterior surface of the molded air duct near the bottom of the duct was analyzed using a Talysurf 10 roughness meter available from Taylor-Hobson to determine surface roughness. Surface roughness was measured by recording the absolute values of deflection (Ra values) from minimum to maximum as the roughness meter was moved along the surface of the part for 6 mm. For example, if the maximum deflection in the negative direction relative to the starting value is 2 microns and the maximum deflection in the positive direction (the direction opposite the negative direction) relative to the starting value is 3 microns, then the absolute deflection (Ra) is 5 microns. The larger the Ra value, the rougher the surface of the air duct. Blow molded air ducts having Ra values below or equal to 5.0 microns are considered to have a smooth surface and pass the blow molding test. Blow molded air ducts having Ra values greater than 5.0 microns are considered to have a rough surface and fail the blow molding test. Numerical values were assigned based on the analysis as indicated below.

1—The blow molded air duct had visible holes on the exterior surface or could not be blow molded due to premature crystallization of the polymer.

2—Surface with Ra values greater than 5.0

3—Surface with Ra values less than or equal to 5.0

A rating of three means that the quality of the surface aspect is excellent with no holes and a smooth surface throughout the entire length of the part. A rating of one means the part had holes in the surface of the part, especially at the opposite extremity from the injection nozzle of the blow molding accumulator head/injection point.

Comparative examples rated as not moldable means that when an attempt was made to blow mold an air duct, the polymer did not flow all the way to the end of the mold resulting in an air duct which was not completely formed. In other words, a portion (typically the portion of the air duct furthest from the injection point) of the blow molded air duct was missing when removed from the mold.

Some parts of home appliances and power tools, as well as many automotive parts, must have the ability to withstand high temperatures experienced in use or during the manufacturing process. Regarding automotive applications, polyamide resins, and in particular, reinforced polyamide resins, are used to manufacture automobile parts such as air ducts and coolant pipes (radiator, engine or heater hoses). For cost reasons, it is desirable to manufacture many of these parts by blow molding methods.

### EXAMPLES

The following materials were used in examples E1-E2 and comparative examples C1-05 of the invention. The compositions in Table 1 were prepared by melt-compounding the ingredients in a 40 mm twin screw extruder (Berstorff UTS 40) operating at about 280° C. using a screw speed of about 300 rpm, a throughput of 115 kg/hour and a melt temperature measured by hand of about 250° C. to 333° C.
Polyamide 6,6—a polyamide prepared from hexamethylenediamine and hexane-1,6-dicarboxylic acid repeat units having a mp of 262° C., a tensile modulus (ISO 527) of 3100 MPa, and an unnotched Charpy impact strength at −30° C. (ISO 179/1 eU) of 400 kJ/m2 and available from E. I. du Pont de Nemours & Co., Inc., Wilmington, Del., USA as Zytel® 101.
VM1—an ethylene/propylene/hexadiene terpolymer grafted with 2.1% maleic anhydride; available from E. I. du Pont de Nemours & Co., Inc., Wilmington, Del., USA as TRX 301.
VM2—an epoxy copolymer of epichlorohydrin and propylene glycol available from The Dow Chemical Company as D.E.R. 732.
SHP—sodium hypophosphite heat stabilizer available from Sigma-Aldrich,
HS—a cuprous iodide/potassium iodide/ metal stearate heat stabilizer in a 7-1-1 ratio (by weight) available from Ciba Specialty Chemicals.
Reinforcing Agent—a glass fiber having a nominal diameter of 10 microns and fiber lengths of about 3.2 mm to 4.5 mm; available from PPG Industries as ChopVantage HP 3660.
DPE—Dipentaerythritol available from Sigma-Aldrich.
TPE—Tripentaerythritol available from Sigma-Aldrich.
EvOH—An ethylene-vinyl alcohol copolymer with 44% ethylene content available as EVAL 105B from Nippon Goshei.
Carbon black—a concentrate of 25% Cabot BP1300 carbon black available from DuPont and dispersed in polyamide 6; The polyamide 6 has a nip of 220° C. and a low viscosity for blow molding and is available from BASF Corporation as Ultramid B3 PA6 polymer.

### Fischer Muller Blow Molding Test

The blow molding test was performed on a Fisher Muller FMB-2140 machine as described above.

The results in table 1 clearly show that the addition of TPE to the polyamide composition provides blow molded parts with excellent surface appearance. When DPE was used at the same concentration (C2) or even higher concentration (C1) in the polyamide composition, the resulting blow molded part had visual surface defects or the part could not be blow molded at all. C4 and C5 show that addition of ethylene vinyl alcohol to the polyamide composition is detrimental to the surface appearance of the polyamide.

When a commercial polyamide, Zytel® BM70G20HSLX BK537 from E. I. du Pont de Nemours & Co., Inc., Wilmington, Del., USA, was blow molded as a control under the same conditions as C1-C5 and E1-E2, the resulting blow molded part had a Fischer Muller blow molding test rating of 1.

TABLE 1

| | E1 | E2 | C1 | C2 | C3 | C4 | C5 | Control |
|---|---|---|---|---|---|---|---|---|
| Polyamide 6,6 | 61.2 | 55.7 | 65.38 | 56.2 | 65.2 | 60.2 | 57.2 | 100^{a} |
| VM1 | 15 | 20 | 8.82 | 20 | 12 | 15 | 15 | 0 |
| VM2 | | 0.5 | 0.5 | | 0.5 | 0.5 | 0.5 | 0 |
| Reinforcing | 20 | 20 | 20 | 20 | 20 | 20 | 20 | 0 |
| Agent | | | | | | | | |
| Carbon Black* | 1.76 | 1.76 | 1.76 | 1.76 | 1.76 | 1.76 | 1.76 | 0 |
| EvOH | | | | | | 1.0 | 4.0 | |
| SHP | 0.04 | 0.04 | 0.04 | 0.04 | 0.04 | 0.04 | 0.04 | 0 |
| DPE | | | 3.0 | 1.5 | | | | 0 |
| TPE | 1.5 | 1.5 | | | | 1.0 | 1.0 | 0 |
| HS | 0.5 | 0.5 | 0.5 | 0.5 | 0.5 | 0.5 | 0.5 | 0 |
| Physical | | | | | | | | |
| Properties | | | | | | | | |
| Fischer Muller | 3 | 3 | Not | 2 | 2 | Not | Not | 1 |
| Rating | | | moldable | | | moldable | moldable | |
| Ra (microns) | 4.6 | 4.1 | | 6.3 | 7.2 | | | |
| Crystallization | | 228.7 | | | 232.0 | | | |
| peak temperature | | | | | | | | |
| (° C.) | | | | | | | | |

*Added as 25% concentrate in polyamide 6
^{a}Zytel BM70G20HSLX BK537

We claim:

1. A thermoplastic composition comprising:
(a) 27 to 91 weight percent of an aliphatic polyamide;
(b) 7 to 30 weight percent polymeric viscosity modifier comprising a reactive functional group, a metal salt of a carboxylic acid, or a combination of them;
(c) 1 to 40 weight percent of one or more reinforcing agents; and
(d) 1.0 to 3 weight percent of tripentaerythritol;
wherein said thermoplastic composition has an Ra value of less than or equal to 5.0 microns when blow molded using a Fisher Muller blow molding test; and wherein all weight percentages are based on the total weight of the thermoplastic composition.

2. The thermoplastic composition of claim 1 wherein the tripentaerythritol is 1.5 to 2.5 weight percent of the composition.

3. The thermoplastic composition of claim 1 wherein the polymeric viscosity modifier is from 10 to 25 weight percent of the composition.

4. The thermoplastic composition of claim 1 wherein the reinforcing agent is from 10 to 40 weight percent of the composition.

5. The thermoplastic composition of claim 1 wherein the aliphatic polyamide is from 40 to 90 weight percent of the composition.

6. The thermoplastic composition of claim 1 wherein the aliphatic polyamide is polyamide 6,6.

7. An article comprising the blow-molding thermoplastic composition of claim 1.

8. The article of claim 7 in the form of an automotive air duct or automotive coolant hose.
